(19) United States
(12) Patent Application Publication
(10) Pub. No.: US 2013/0107187 A1
(43) Pub. Date: May 2, 2013

(54) PIXEL STRUCTURE

(71) Applicants: Min-Yao Lu, Taichung City (TW); Yu-Yang Chang, Hsinchu County (TW); Chao-Chiun Liang, Hsinchu City (TW); Heng-Yin Chen, Hsinchu County (TW)

(72) Inventors: Min-Yao Lu, Taichung City (TW); Yu-Yang Chang, Hsinchu County (TW); Chao-Chiun Liang, Hsinchu City (TW); Heng-Yin Chen, Hsinchu County (TW)

(73) Assignee: INDUSTRIAL TECHNOLOGY RESEARCH INSTITUTE, Hsinchu (TW)

(21) Appl. No.: 13/448,401

(22) Filed: Apr. 17, 2012

(30) Foreign Application Priority Data
Nov. 1, 2011 (TW) 100139853
Feb. 8, 2012 (TW) 101104107

(51) Int. Cl. G02F 1/1335; G02F 1/1333; G02F 1/167; G02F 1/01; G02B 26/00

(52) U.S. Cl. 349/176; 359/238; 359/290; 359/296

(57) ABSTRACT

A pixel structure having a plurality of display regions is provided. The pixel structure includes a transparent substrate, an active device layer, and a plurality of reflective display units. The transparent substrate has a first side and a second side opposite to each other. The active device layer is disposed on one of the first side and the second side of the substrate. The reflective display units are respectively located in the display regions and driven by the active device layer. Two reflective display units are located at the same display region to provide different display colors. Two closely adjacent display regions provide different display colors when display simultaneously.

### CROSS-REFERENCE TO RELATED APPLICATION

This application claims the priority benefits of Taiwan application serial no. 100139853, filed on Nov. 1, 2011, and Taiwan application serial no. 101104107, filed on Feb. 8, 2012. The entirety of each of the above-mentioned patent applications is hereby incorporated by reference herein and made a part of specification.

### TECHNICAL FIELD

The disclosure relates to a pixel structure. Particularly, the disclosure relates to a pixel structure using a bistable display medium to display.

### BACKGROUND

With development of display technology, types of displays are developed, which are grouped into self-luminescence displays and light modulating displays according to different display media used therein. The self-luminescence displays can emit light themselves and achieve different gray levels by controlling the light-emitting brightness thereof, so as to produce image frames. The light modulating displays cannot emit light by themselves, instead, they achieve desired gray levels by modulating the received external light through the light valve function of the display medium thereof.

The light modulating displays include transmissive, reflective and transflective light modulating displays. The transmissive light modulating display is generally used together with a backlight module for providing a backlight source, in which the amount of light from the backlight module allowed to pass through the display is modulated to form different gray levels, so as to produce image frames. The reflective light modulating display achieves different gray levels by providing different reflectivity levels for the incident light, so as to produce image frames. The transflective light modulating display combines functions of the transmissive and reflective light modulating displays.

A display medium used in the reflective light modulating display generally has a bistable feature, i.e. the display medium can maintain its display state without using an external power under a stable state. Therefore, the reflective light modulating display has the characteristic of low power consumption, and has desirable black-white display effect. Presently, display techniques of using the bistable display medium include electronic ink (E-Ink) display, cholesteric liquid crystal display (ChLCD), electro-phoretic display (EPD), electrowetting display (EWD) and quick response-liquid powder display (QR-LPD), etc. However, such types of display are not easy to implement a colorful display.

Regarding the E-Ink display, in order to achieve a multi-color display effect, the display medium of single color is required to be controlled by an active device array substrate according to a current design. Therefore, when display media of three colors are required to achieve the multi-color display function, three active device array substrates are required. Moreover, the three display media need be arranged in a vertical stacking manner to implement the colors to be displayed, and the three active device array substrates thus have to be aligned precisely. Overall, in order to implement an ideal multi-color display effect, the E-Ink display technique still has problems of great thickness, complicate structure and high fabrication cost, and the like that are required to be resolved.

### SUMMARY

An embodiment is directed to a pixel structure, in which a single-active device layer substrate is used to drive a bistable display medium to implement multi-color display, so as to achieve features of thin and simple in structure and simple in fabrication process.

An embodiment provides a pixel structure having a plurality of display regions. The pixel structure includes a transparent substrate, an active device layer, and a plurality of reflective display units. The transparent substrate has a first side and a second side opposite to each other. The active device layer is disposed on one of the first side and the second side of the substrate. The reflective display units are respectively located in the display regions and driven by the active device layer. Two reflective display units are located at the same display region and respectively disposed on the first side and the second side of the substrate to provide two display colors. Two closely adjacent display regions provide different display colors when display simultaneously.

In an embodiment, the reflective display units include a first color display unit, a second color display unit and a plurality of third color display units, and the two closely adjacent display regions are respectively a first display region and a second display region, a first one of the third color display units and the first color display unit are both located in the first display region, and a second one of the third color display units and the second color display units are both located in the second display region. The first color display unit and the second color display units are disposed on the first side of the substrate, and the third color display units are disposed on the second side of the substrate. Moreover, the third color display units are respectively disposed on the first side and the second side of the substrate, the first color display unit is disposed on one of the first side and the second side of the substrate, and the second color display unit is disposed on the other one of the first side and the second side of the substrate. Moreover, the reflective display units further include a fourth color display unit, and the display regions further include a third display region, and a third one of the third color display units and the fourth color display unit are both located in the third display region, such that the first display region, the second display region and the third display region provide different display colors when display simultaneously.

In an embodiment, the display colors of the reflective display units include complementary colors of the three primary colors, a white color or a black color.

In an embodiment, each of the reflective display units includes a reflective display medium, and the reflective display medium includes a bistable display material. For example, the bistable display material includes an electronic ink (E-Ink), a cholesteric liquid crystal display (ChLCD) material, an electro-phoretic display (EPD) material, an electrowetting display (EWD) material or a quick response-liquid powder display (QR-LPD) material.

In an embodiment, the pixel structure further includes a reflection layer, and the substrate and the reflective display units are all located at a same side of the reflection layer. The reflection layer is a black reflection layer or a white reflection layer.

In an embodiment, the pixel structure further includes an absorbing layer, and the substrate and the reflective display units are all located at a same side of the absorbing layer.

In an embodiment, the two closely adjacent display regions display simultaneously to present one of the three primary colors.

In an embodiment, the two display colors provided by a same display region are mixed to be one of the three primary colors.

According to the above descriptions, the active device layer capable of double side driving is used to drive the reflective display units disposed on the upper and lower sides of the substrate to implement the multi-color display effect. Therefore, the pixel structure of the disclosure has characteristics of simple structure and simple fabrication process, etc.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a pixel structure according to a first embodiment of the disclosure.

FIGS. 2A-2C are schematic diagrams of display colors of a pixel structure according to the first embodiment of the disclosure.

FIG. 3A and FIG. 3B are schematic diagrams of display colors of a pixel structure according to a second embodiment of the disclosure.

FIG. 4 illustrates a pixel structure according to a third embodiment of the disclosure.

FIG. 5 illustrates a pixel structure according to a fourth embodiment of the disclosure.

FIG. 6 illustrates a pixel structure according to a fifth embodiment of the disclosure.

FIG. 7 illustrates a pixel structure according to a sixth embodiment of the disclosure.

### DETAILED DESCRIPTION OF DISCLOSED EMBODIMENTS

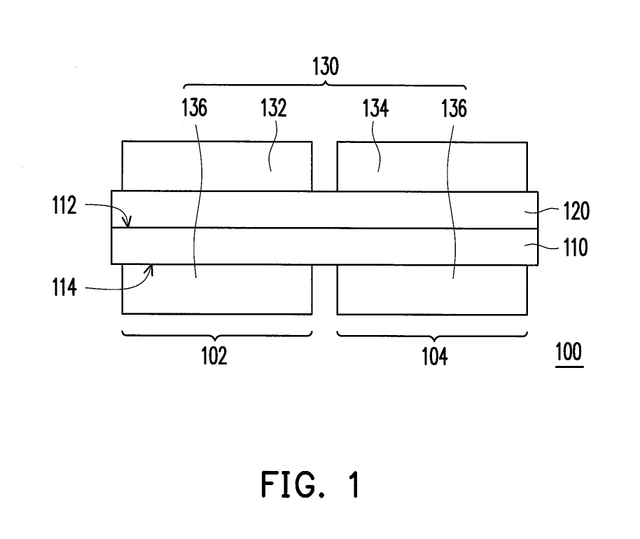

FIG. 1 is a schematic diagram of a pixel structure according to a first embodiment of the disclosure. Referring to FIG. 1, the pixel structure 100 has a plurality of display regions 102 and 104. The pixel structure 100 includes a transparent substrate 110, an active device layer 120, and a plurality of reflective display units 130. The transparent substrate 110 has a first side 112 and a second side 114 opposite to each other. The active device layer 120 is disposed on one of the first side 112 and the second side 114 of the substrate 110, and in the present embodiment, the active device layer 120 is disposed on the first side 112 of the substrate 110, though in other embodiments, the active device layer 120 can also be disposed on the second side 114 of the substrate 110. Moreover, the reflective display units 130 are respectively located in the display regions 102 and 104, and are all driven by the active device layer 120. Namely, although the active device layer 120 is only located on the first side 112 of the substrate 100, it can simultaneously drive the reflective display units 130 located on the first side 102 and the reflective display units 130 located on the second side 104. Certainly, the active device layer 120 can also selectively merely drive the reflective display units 130 located on the first side 102 or drive the reflective display units 130 located on the second side 104. Overall, whether the active device layer 120 drives the reflective display units 130 in a double side driving mode or in a single side driving mode is not limited by the disclosure.

The reflective display units 130 include a first color display unit 132, a second color display unit 134 and a third color display unit 136, where the number of each color reflective display units 130 is not specifically limited, and in the present embodiment, one first color display unit 132, one second color display unit 134 and two third color display units 136 are taken as an example for descriptive purposes. Each of the reflective display units 130 includes a reflective display medium, which is, for example, a bistable display material. Generally, the bistable display material includes an electronic ink (E-Ink), a cholesteric liquid crystal display (ChLCD) material, an electro-phoretic display (EPD) material, an electrowetting display (EWD) material or a quick response-liquid powder display (QR-LPD) material, though the disclosure is not limited thereto.

Moreover, in the reflective display units 130, two reflective display units 130 are located at the same display region 102 or 104 and are respectively disposed on the first side 112 and the second side 114 of the substrate 110. In detail, the first color display unit 132 and one of the third color display units 136 are both located in the display region 102, and the display region 102 can be defined as a first display region in the present embodiment. Meanwhile, the second color display unit 134 and the other one of the third color display unit 136 are both located in the display region 104, and the display region 104 can be defined as a second display region in the present embodiment. To facilitate describing an implementation of the pixel structure 100, the first display region 102 and the second display region 104 are used to represent these display regions. Moreover, in the present embodiment, the first display region 102 and the second display region 104 are two closely adjacent display regions in the pixel structure 100.

The first color display unit 132, the second color display unit 134 and the third color display units 136 are, for example, display units of different colors. Namely, the first color display unit 132 and the third color display unit 136 located in the first display region 102 can display different display colors, and meanwhile the second color display unit 134 and the third color display unit 136 located in the second display region 104 can display different display colors. Therefore, the first display region 102 can substantially provide two display colors, and the second display region 104 does the same.

For example, the display colors of the reflective display units 130 can be complementary colors of the three primary colors, for example, a cyan color, a magenta color and a yellow color. When the pixel structure 100 displays, the active device layer 120 can selectively drive one of the reflective display units 130 in the first display region 102 and one of the reflective display units 130 in the second display region 104. Under the above configuration of the reflective display units 130, the closely adjacent first display region 102 and the second display region 104 may provide different display colors when display simultaneously. For example, the first display region 102 and the second display region 104 can simultaneously display two of the cyan color, the magenta color and the yellow color. Therefore, based on simultaneous display of the first display region 102 and the second display region 104, two of the cyan color, the magenta color and the yellow color can be mixed to present a required one of the three primary display colors of the pixel structure 100.

In other words, the pixel structure 100 may obtain one of red color, green color and blue color by simultaneously driving (or driving in time-division) two of the first color display unit 132, the second color display unit 134 and the third color display unit 136 and mixing the displayed colors thereof. Now, multiple pixel structures 100 with the aforementioned design can be used to form a display panel with a multi-color display function. Since the pixel structure 100 of the present embodiment only uses a single substrate 110 and a single active device layer 120, it has characteristics of thin and simple in structure.

In order to clearly describe the display method of the pixel structure 100, the display colors of the first color display unit 132, the second color display unit 134 and the third color display unit 136 are, for example, respectively set to the yellow color, the magenta color and the cyan color for descriptions. However, such color combination is only used as an example, which is not used to limit the disclosure. Namely, in other embodiments, the display colors of the first color display unit 132, the second color display unit 134 and the third color display unit 136 can be set to any combination of the yellow color, the magenta color and the cyan color.

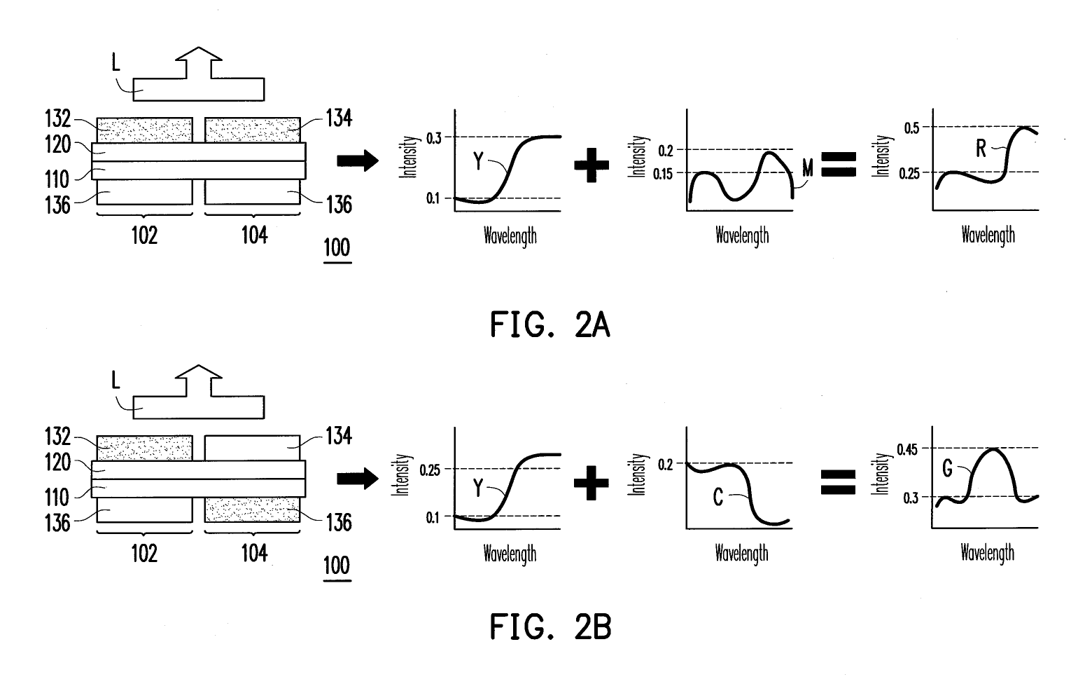

FIGS. 2A-2C are schematic diagrams of display colors of a pixel structure according to the first embodiment of the disclosure. In FIGS. 2A-2C, the areas defined by small dots are used to represent the driven display units. Referring to FIG. 2A, the active device layer 120 simultaneously drives (or drives in time division) the first color display unit 132 at the first display region 102 and the second color display unit 134 at the second display region 104. Now, the first color display unit 132 and the second color display unit 134 are located at a same side of the substrate 110, so that the active device layer 120 may have a single side driving mode. The first color display unit 132 and the second color display unit 134 are respectively a yellow color display unit and a magenta color display unit, and wavelength-intensity relationships of display lights thereof are respectively shown as a curve Y and a curve M. Therefore, a wavelength-intensity relationship of a display light L of the pixel structure 100 herein is shown as a curve R obtained by superposing the curve Y and the curve M. According to the curve R, it is known that the display light L substantially provides a red display color.

Then, referring to FIG. 2B, the active device layer 120 simultaneously drives (or drives in time division) the first color display unit 132 at the first display region 102 and the third color display unit 136 at the second display region 104. Now, the first color display unit 132 and the third color display unit 136 are respectively located at two opposite sides of the substrate 110, so that the active device layer 120 may have a double side driving mode. The first color display unit 132 and the third color display unit 136 are respectively a yellow color display unit and a cyan color display unit, and wavelength-intensity relationships of display lights thereof are respectively shown as the curve Y and a curve C. Therefore, the wavelength-intensity relationship of the display light L of the pixel structure 100 is shown as a curve G obtained by superposing the curve Y and the curve C. According to the curve G, it is known that the display light L substantially provides a green display color.

Then, referring to FIG. 2C, the active device layer 120 simultaneously drives (or drives in time division) the third color display unit 136 at the first display region 102 and the second color display unit 134 at the second display region 104. Now, the third color display unit 136 and the second color display unit 134 are respectively located at two opposite sides of the substrate 110, so that the active device layer 120 may have the double side driving mode. The third color display unit 136 and the second color display unit 134 are respectively the cyan color display unit and the magenta color display unit, and wavelength-intensity relationships of display lights thereof are respectively shown as the curve C and the curve M. Therefore, the wavelength-intensity relationship of the display light L of the pixel structure 100 is shown as a curve B obtained by superposing the curve C and the curve M. According to the curve B, it is known that the display light L substantially provides a blue display color.

Overall, the pixel structure 100 can use one active device layer 120 to display the display colors of the three primary colors (the red color, the green color and the blue color), so as to achieve a simple structure design. Meanwhile, in the present embodiment, it is unnecessary to use multiple active device layers 120, so that it is unnecessary to execute a precise and complicated assembling method to align the multiple active device layers precisely. Therefore, the pixel structure 100 provides a design of using a simple fabrication method to implement the multi-color display effect. Moreover, it should be noticed that in the display methods shown by FIGS. 2A-2C, an addition color mixing principle is used to obtain the display colors of the three primary colors, though in other embodiments, the required display colors can be obtained based on a subtraction color mixing principle.

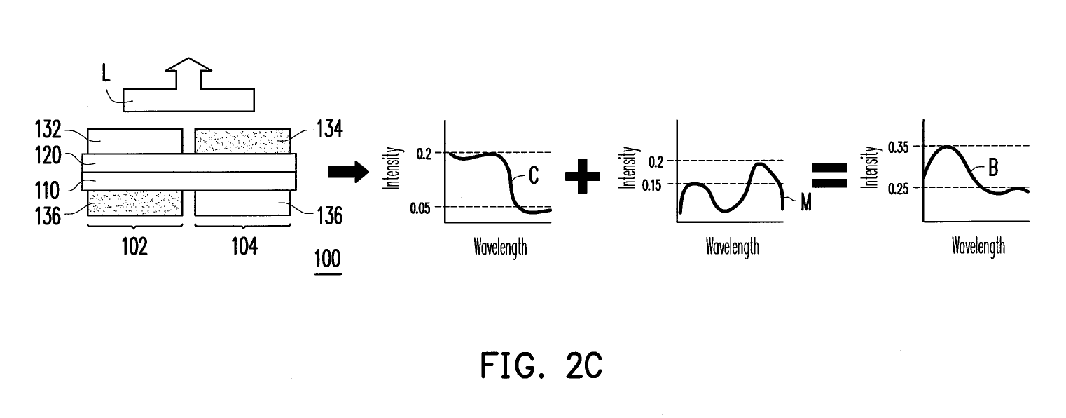

FIG. 3A and FIG. 3B are schematic diagrams of display colors of a pixel structure according to a second embodiment of the disclosure. Referring to FIG. 3A, the pixel structure 200 is similar to the aforementioned pixel structure 100, and the same reference numbers in the two embodiments denote the same components. In detail, a main difference of the two pixel structures 100 and 200 is that the first color display unit 132 and the second color display unit 134 of the pixel structure 200 are disposed on the second side 114 of the substrate 110, and the third display units 136 are disposed on the first side 112 of the substrate 110. When the pixel structure 200 displays, similar to the first embodiment, the active device layer 120 drives one of the display units in the first display region 102, and simultaneously drives (or drives in time-division) one of the display units in the second display region 104. Now, the pixel structure 200 may selectively have the required display effect based on the addition color mixing principle. However, as the addition color mixing display method has been described in the aforementioned embodiment, a subtraction color mixing display method is described below.

In the present embodiment, the display colors of the first color display unit 132, the second color display unit 134 and the third color display unit 136 are, for example, respectively set to the cyan color, the magenta color and the yellow color for descriptions. First, referring to FIG. 3A, a display method of the pixel structure 200 is, for example, to simultaneously drive (or drive in time-division) the second color display unit 134 in the second display region and the third color display unit 136 in the second display region 104 by the active device layer 120. Namely, the active device layer 120 operates in the double side driving mode to drive the pixel structure 200 to display.

The second color display unit 134 and the third color display unit 136 are respectively a magenta color display unit and a yellow color display unit, and wavelength-intensity relationships of display lights thereof are respectively shown as a curve Y and a curve M. Now, as the second color display unit 135 and the third color display unit 136 are all located in the second display region 104, a wavelength-intensity relationship of a display light L of the pixel structure 200 is shown as a curve G obtained by subtracting the curve M from the curve Y. According to the curve G, it is known that the display light L substantially provides a green display color.

Moreover, referring to FIG. 3B, under a same structure design, the pixel structure 200, for example, simultaneously drives (or drives in time division) the two color display units in the first display region 102, i.e. the first color display unit 132 and the third color display unit 136 in the first display region 102. The first color display unit 132 and the third color display unit 136 are respectively a cyan color display unit and a yellow color display unit, and wavelength-intensity relationships of display lights thereof are respectively shown as the curve C and the curve Y. Now, the driven first color display unit 132 and the driven third color display unit 136 are all located in the first display region 102, so that the wavelength-intensity relationship of the display light L of the pixel structure 200 is shown as a curve R obtained by subtracting the curve C from the curve Y. According to the curve R, it is known that the display light L substantially provides a red display color.

Moreover, under the design of the pixel structure 200, in order to display a blue display color, the active device layer 120 can simultaneously drive (or drive in time division) the first color display unit 132 in the first display region 102 and the second color display unit 134 in the second display region 104. In this way, the blue display color can be obtained by superposing the cyan color displayed by the first color display unit 132 and the magenta coor displayed by the second color display unit 134. Namely, the display method of the pixel structure 200 is not limited by the disclosure, and in order to obtain the required display color, the pixel structure 200 may apply the addition color mixing principle or the subtraction color mixing principle or both of the two principles. Moreover, in the aforementioned embodiments, in order to describe the display methods of the pixel structures 100 and 200, colors of various display units are illustrated, though a combination method of these colors are not limited thereto.

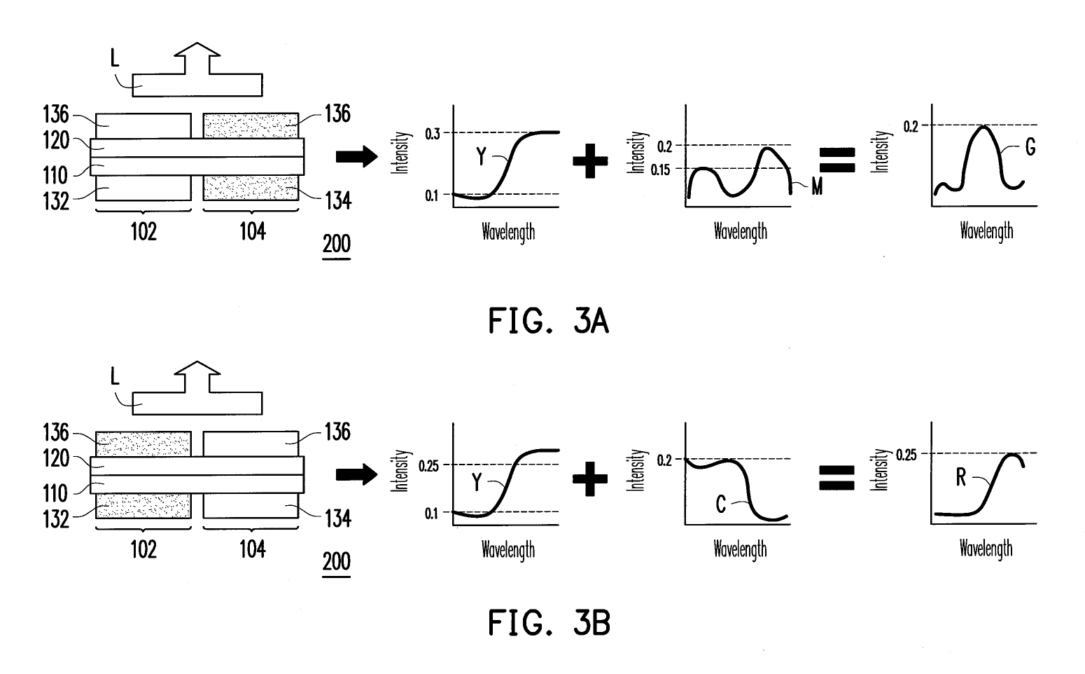

FIG. 4 illustrates a pixel structure according to a third embodiment of the disclosure. Referring to FIG. 4, the pixel structure 300 is substantially similar to the pixel structure 100, and the same reference numbers in the pixel structure 300 and the pixel structure 100 denote the same components. In detail, besides the components included in the pixel structure 100, the pixel structure 300 further includes a reflection layer 310, and the substrate 110, the active device layer 120, the first color display unit 132, the second color display unit 134 and the third color display units 136 are all located at a same side of the reflection layer 310. Namely, the reflection layer 310 can be disposed at the outmost layer of the pixel structure 300.

In the present embodiment, the active device layer 120 may drive in the single side driving mode or the double side driving mode to obtain the required color. Moreover, the reflection layer 310 can be selectively a white reflection layer, which avails improving reflectivity and display brightness of the pixel structure 300. For example, a material of the reflection layer 310 can be inks, resins, oxide coatings, etc. When the reflection layer 310 is white, it can reflect most of incident visible light to increase the display brightness of the pixel structure 300.

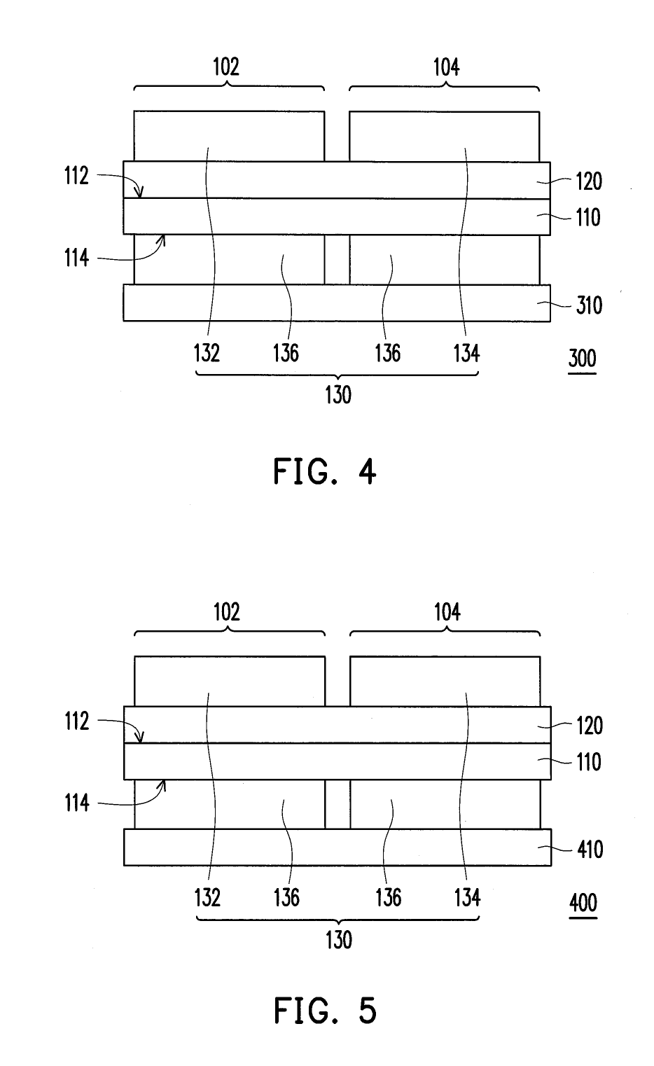

FIG. 5 illustrates a pixel structure according to a fourth embodiment of the disclosure. Referring to FIG. 5, the pixel structure 400 is substantially similar to the pixel structure 100, and the same reference numbers in the pixel structure 400 and the pixel structure 100 denote the same components. In detail, besides the components included in the pixel structure 100, the pixel structure 400 further includes an absorbing layer 410, and the substrate 110, the active device layer 120, the first color display unit 132, the second color display unit 134 and the third color display units 136 are all located at a same side of the absorbing layer 410. Namely, the absorbing layer 410 can be disposed at the outmost layer of the pixel structure 400. In the present embodiment, a material of the absorbing layer 410 can be inks, resins, oxide coatings, etc., which avails improving a contrast and color purity of the pixel structure 400. Similar to the aforementioned embodiments, the active device layer 120 may drive in the single side driving mode or the double side driving mode to obtain the required color.

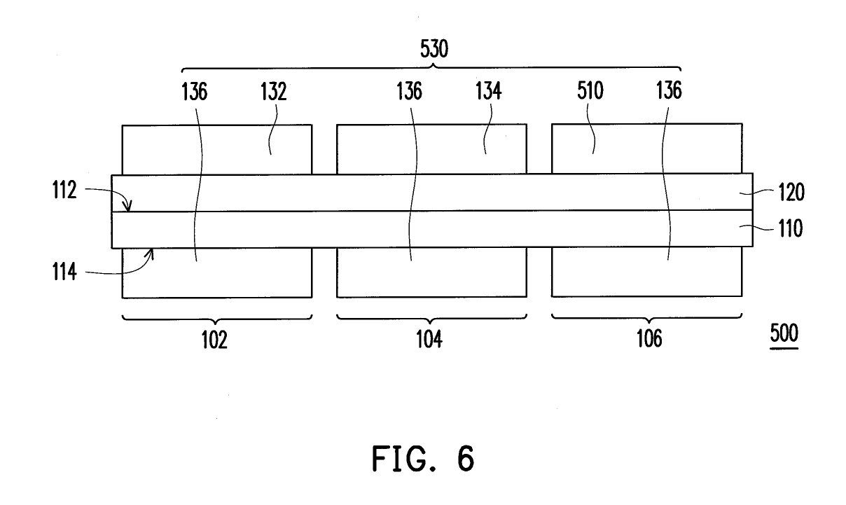

FIG. 6 illustrates a pixel structure according to a fifth embodiment of the disclosure. Referring to FIG. 6, besides all of the components included in the pixel structure 100, the pixel structure 500 further includes a fourth color display unit 510, which is disposed on the first side 112 of the substrate 110. Moreover, the number of the third color display units 136 of the reflective pixel unit 500 is three, and a third one of the third color display units 136 is disposed opposite to the fourth color display unit 510 to define a third display region 106.

Namely, the pixel structure 500 of the present embodiment is composed of six reflective display units 530, where the first color display unit 132, the second color display unit 134 and the fourth color display unit 510 are all located at the first side 112 of the substrate 110, and the three third color display units 136 are all located at the second side 114 of the substrate 110. The first color display unit 132, the second color display unit 134, the third color display units 136 and the fourth color display unit 510 may respectively display different colors, for example, the complementary colors of the three primary colors, the black color or the white color, though the disclosure is not limited thereto.

In detail, when the pixel structure 500 displays, the first color display unit 132 or the third color display unit 136 located in the first display region 102 can be selectively driven, meanwhile the second color display unit 134 or the third color display unit 136 located in the second display region 104 can be selectively driven, and meanwhile the fourth color display unit 510 or the third color display unit 136 located in the third display region 106 can be selectively driven, so as to obtain the required display color. Namely, the active device layer 120 can selectively drive a part of the reflective pixel units 530 to make the first display region 102, the second display region 104 and the third display region 106 to provide different display colors, so as to obtain the required display effect based on the addition color mixing principle or the subtraction color mixing principle. In other words, the active device layer 120 may drive in the single side driving mode or the double side driving mode to obtain the required colors.

It should be noticed that the fourth color display unit 510 of the present embodiment can be a white color display unit. Therefore, when the fourth color display unit 510 is driven, a whole brightness of the pixel structure 500 is improved. Moreover, when only the fourth color display unit 510 of the pixel structure 500 is driven, a white frame is displayed. In other embodiments, display of the white frame can be implemented by simultaneously driving (or driving in time-division) a plurality of the reflective display units 530. For example, when the first color display unit 132, the second color display unit 134 and the third color display units 136 are respectively the cyan, magenta and yellow display units, the white frame can be displayed by simultaneously driving (or driving in time-division) the first color display unit 132, the second color display unit 134 and one of the third color display unit 136 at the first region 102, the second region 104, and the third region 106. Moreover, the pixel structure 500 can selective include the reflection layer illustrated in FIG. 4 or the absorbing layer illustrated in FIG. 5, so as to achieve ideal display quality of a high display brightness and high contrast.

The pixel structure 500 of the present embodiment is not used to limit the disclosure. In other embodiments, the reflective display units 530 can be arranged according to other methods. For example, the first color display unit 132 and the third odor display unit 136 in the first display region 102 can be exchanged, the second color display unit 134 and the third odor display unit 136 in the second display region 104 can be exchanged, or the fourth color display unit 510 and the third odor display unit 136 in the third display region 106 can be exchanged. Namely, the three third color display units 136 are not limited to be located at the same side of the substrate 110. Certainly, regarding the pixel structure 200 of FIG. 1, the two reflective display units 130 in the same display region can also be exchanged.

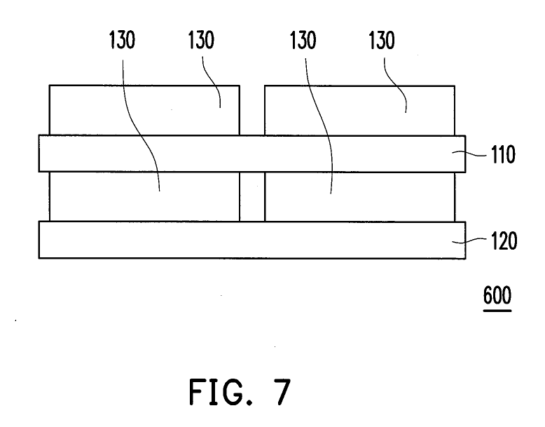

Further, FIG. 7 illustrates a pixel structure according to a sixth embodiment of the disclosure. Referring to FIG. 7, the pixel structure 600 of the present embodiment is similar to the pixel structure 100 of the first embodiment, where the active device layer 120 of the pixel structure 600 has single side driving design, so that all of the reflective display units 130 are located at the same side of the active device layer 120. Namely, one pair of the reflective display units 130 are located at one side of the substrate 110, the other pair of the reflective display units 130 are located at the other side of the substrate 110, and the active device layer 120 is located at a side of one of the two pairs away from the substrate 110. In other words, regarding the substrate 110, the active device layer 120 and the reflective display units 130, the active device layer 120 is located at a lowest (outermost) part in the pixel structure 600 of FIG. 7. Moreover, the active device layer 120 configured in all the aforementioned embodiments may have the single side driving design, so that the design of disposing all the reflective display units 130 at the same side of the active device layer 120 can be applied to all of the aforementioned embodiments.

In summary, the pixel structure of the disclosure may use the active device layer capable of double side driving to drive the reflective display units disposed on the upper and lower sides of the substrate. Since the reflective display units disposed on the upper and lower sides of the substrate provide different display colors, a color mixing method can be adopted to obtain the required display effect. Moreover, in the pixel structure of the disclosure, by selecting the color display media, the two closely adjacent display regions display different colors to provide the required colorful display effect. In this way, the pixel structure is unnecessary to use multiple of active device substrates to drive the multiple layers of color display units, so that it may have characteristics of thin and simple in structure. Further, since the pixel structure of the disclosure only uses a single substrate, it is unnecessary to use a complicated assembling method to align multiple of active device substrates precisely, so that a fabrication method thereof is simple.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A pixel structure, having a plurality of display regions, and the pixel structure comprising:
a transparent substrate, having a first side and a second side opposite to each other;
an active device layer, disposed on one of the first side and the second side of the substrate;
a plurality of reflective display units, respectively located in the display regions and driven by the active device layer, wherein two reflective display units are located in the same display region to provide two display colors.

2. The pixel structure as claimed in claim 1, wherein the reflective display units comprise a first color display unit, a second color display unit and a plurality of third color display units, and the two closely adjacent display regions are respectively a first display region and a second display region, a first one of the third color display units and the first color display unit are both located in the first display region, and a second one of the third color display units and the second color display unit are both located in the second display region.

3. The pixel structure as claimed in claim 2, wherein the first color display unit and the second color display unit are disposed on the first side of the substrate, and the third color display units are disposed on the second side of the substrate.

4. The pixel structure as claimed in claim 2, wherein the third color display units are respectively disposed on the first side and the second side of the substrate, the first color display unit is disposed on one of the first side and the second side of the substrate, and the second color display unit is disposed on the other one of the first side and the second side of the substrate.

5. The pixel structure as claimed in claim 2, wherein the reflective display units further comprise a fourth color display unit, and the display regions further comprise a third display region, and a third one of the third color display units and the fourth color display unit are both located in the third display region, such that the first display region, the second display region and the third display region provide different display colors when display simultaneously.

6. The pixel structure as claimed in claim 1, wherein the display colors of the reflective display units comprise complementary colors of three primary colors, a white color or a black color.

7. The pixel structure as claimed in claim 1, wherein each of the reflective display units comprises a reflective display medium.

8. The pixel structure as claimed in claim 7, wherein the reflective display medium comprises a bistable display material.

9. The pixel structure as claimed in claim 8, wherein the bistable display material comprises an electronic ink (E-Ink), a cholesteric liquid crystal display (ChLCD) material, an electro-phoretic display (EPD) material, an electrowetting display (EWD) material or a quick response-liquid powder display (QR-LPD) material.

10. The pixel structure as claimed in claim 1, further comprising a reflection layer, wherein the substrate and the reflective display units are all located at a same side of the reflection layer.

11. The pixel structure as claimed in claim 10, wherein the reflection layer is a white reflection layer.

12. The pixel structure as claimed in claim 1, further comprising an absorbing layer, wherein the substrate and the reflective display units are all located at a same side of the absorbing layer.

13. The pixel structure as claimed in claim 1, wherein the two closely adjacent display regions display simultaneously to present one of three primary colors.

14. The pixel structure as claimed in claim 1, wherein the two display colors provided by a same display region are mixed to be one of three primary colors.

15. The pixel structure as claimed in claim 1, wherein the two reflective display units located in a same display region are respectively disposed on the first side and the second side of the substrate.

16. The pixel structure as claimed in claim 15, wherein the reflective display units are all located at a same side of the active device layer.

17. The pixel structure as claimed in claim 15, wherein the reflective display units are respectively located at two opposite sides of the active device layer.
